(19) United States
(12) Patent Application Publication
(10) Pub. No.: US 2017/0282082 A1
(43) Pub. Date: Oct. 5, 2017

(54) AUTOMATED TOURNAMENT PLATFORM FOR ONLINE VIDEO GAMES

(71) Applicant: ATTAQ Online, Inc., Magnolia, TX (US)

(72) Inventor: Alan Lloyd HUBBARD, Montgomery, TX (US)

(73) Assignee: ATTAQ Online, Inc., Magnolia, TX (US)

(21) Appl. No.: 15/169,068

(22) Filed: May 31, 2016

Related U.S. Application Data
(60) Provisional application No. 62/168,590, filed on May 29, 2015.

(51) Int. Cl. A63F 13/798; A63F 13/795; G06F 3/048; A63F 13/335

(52) U.S. Cl. CPC A63F 13/798; A63F 13/335; A63F 13/795; G06F 3/048

(57) ABSTRACT

An on-line tournament management process includes a team substitution feature suitable when one tournament team loses a player to a disconnection or other unforeseen circumstance. The process may include maintaining roster information for first and second teams. Responsive to detecting a lost connection corresponding to a first player of the first team, performing substitution operations that may include: accessing skill level attributes of the first player, performing a search for a replacement player for replacing the first player in accordance with the skill level attributes and offering at least some eligible standby players, determined in accordance with criteria for matching the skill level attributes of the first player, a substitution spot corresponding to the open roster spot. After monitoring for an acceptance from an eligible player and not receiving an acceptance, additional eligible standby players may be offered the substitution spot. Additional eligible players may be identified by relaxing the degree of matching criteria.

This application claims priority to U.S. Provisional Patent Application 62/168,590, filed May 29, 2015, which is herein incorporated by reference in its entirety. An Application Data Sheet filed contemporaneously herewith includes a corresponding priority claim.

### BACKGROUND OF THE INVENTION

### Field of the Invention

The invention relates generally to an online tournament platform that facilitates automated on-demand tournaments for video games.

### Related Art

In the field of online video game tournaments, especially for team-based video games, existing tournament management tools lack the ability to accurately create, match, and handicap teams and/or players for a given tournament and offer no solution for a team that loses a player, whether due to unfortunate Internet connection drops, or other circumstances that would cause a player to leave a team mid tournament. A group of players may create pre-made teams to participate in a tournament, but manual team creation can be time consuming and does not address the needs of players who are not a part of such a group, or the needs of a team when one or more of its players drops out, either intentionally or otherwise, of the tournament.

### SUMMARY

Disclosed systems, services, and software include features of a tournament creation and management platform with various features including, as non-limiting examples: a Matchmaking Service, a Team Creation Service, a Player Substitution Service, an On Demand Tournament Service, and a combination of these services as it is applied to an online tournament platform. Disclosed services enable a single player to join into a tournament team of other single players, using criteria such as tournament type, skill of the individual players and total skill of teams in a tournament.

Tournament platform systems, services, and software disclosed herein include a method and online venue that associates individual players with a tournament. A disclosed and automated matchmaking process may place that player into a larger pool of players, organize the players in the pool by skill, and place them into teams with overall team skill balancing as a primary objective for a tournament.

Matchmaking processes described herein may utilize a modified Elo algorithm to assess a player's strength in the context of creating teams for tournament play for the primary purpose of tournament and team creation. Elo rating refers to a rating system method for calculating the relative skill levels of players in competitor-versus-competitor games. Elo rating is used as a rating system for multiplayer competition in a number of video games.

The difference between the Elo ratings for two players is intended to serve as an indicator of the outcome of a match between the two players. Two players with equal Elo ratings who play against each other might be expected to score an equal number of wins. A player whose rating is 100 points greater than the player's opponent is expected to score 64% of a match's points (e.g., 64 to 36). If the difference is 200 points, then the expected score for the stronger player is 76% (e.g., 76 to 24).

Elo ratings may increase or decrease following a match, depending on the outcome of games between rated players. After every game, winning players takes points from losing players. The difference between the ratings of the winner and loser determines the total number of points gained or lost after a game. In a series of games between a high-rated player and a low-rated player, the high-rated player is expected to score more wins. If the high-rated player wins, then only a few rating points will be taken from the low-rated player. However, if the lower rated player scores an upset win, many rating points will be transferred. The lower rated player will also gain a few points from the higher rated player in the event of a draw. This means that this rating system is self-correcting. A player whose rating is too low should, in the long run, do better than the rating system predicts, and thus gain rating points until the rating reflects their true playing strength.

Tournament platform features disclosed herein include, but are not limited to at least the following features:

Tournament Creation—Tournament platform features include an on demand tournament service that will launch a tournament in response to identifying a particular number of players in a virtual queue. The tournament service may search for players of similar skill level, and expand its search as time begins to elapse, filling the queue with the appropriate players. The service may permit players to be queuing on multiple queues simultaneously. As new, unattached players continue to queue up, the tournament service may prioritize queues based on parameters such as percentage of tournament ready and percentage of players that prioritize queue X. Like a revolving door, these on demand tournaments may continually launch indefinitely once the criteria to launch is met.

Team Creation—Tournament platform services described herein may create balanced or skill=comparable teams for a given tournament to increase competitiveness and provide a better experience for the tournament participants. The tournament platform services may invoke a skill based matchmaking algorithm and assign a strength value or a set of strength values to each player. The order of selection among the teams may be determined randomly. Generally, players in a tournament queue may be assigned to teams based upon their skill so that the most skilled player remaining is the next player selected, e.g., the first team to pick will generally pick the strongest available player and this process may be repeated until all players are assigned to teams. For each round, the weakest team has the highest probability of picking first, but the lottery system may adjust the final pick order for any given round. This process adds an element of randomness that prevents cheating or collusion.

Player substitutions On occasion, a player may lose internet connection, or be unable to continue play due to uncontrollable, outside circumstances. In team-based tournaments, this can leave that team at a numerical disadvantage for the tournament. Tournament platform services described herein may include a player substitution feature that automatically replaces a missing player based at least in part on the replacement player matching the lost player's skill rating. The substitution process may be performed between rounds. 50 players at a time may be there to give them the option to fill the empty roster spot on a team. After a certain amount of elapsed time, the system may ping an additional 50 players. This process may continue until a substitution is made.

### BRIEF DESCRIPTION OF THE DRAWINGS

FIG. 1 illustrates elements of an on demand tournament creation process;

FIG. 2 illustrates elements of a multi-queue feature enabling a player to wait for an opening;

FIG. 3 illustrates elements of a team creation process for use with the process of FIG. 1;

FIG. 4 illustrates elements of a substitution feature suitable for use when a team loses a connection with player unexpectedly;

FIGS. 5, 6, and 7 illustrate example user interfaces for an on demand tournament store; and

FIG. 8 illustrates an on demand tournament management server.

### DETAILED DESCRIPTION

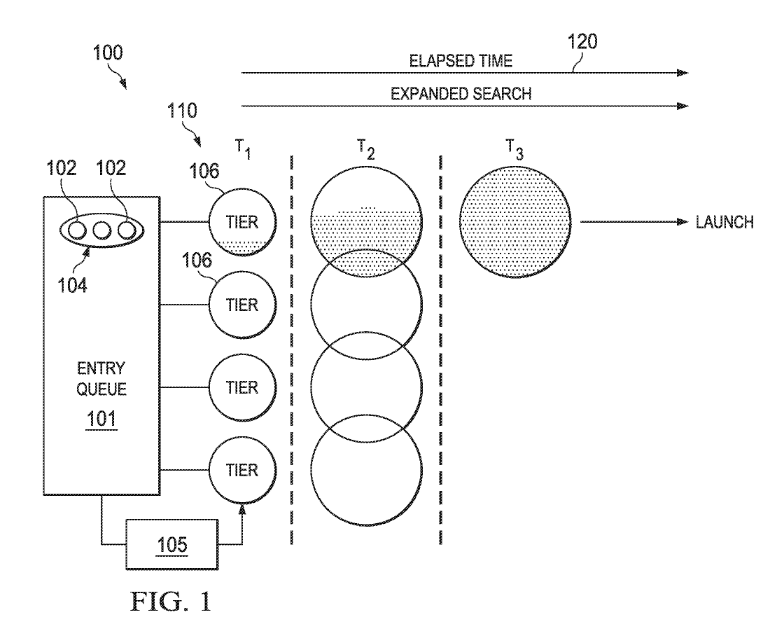

FIG. 1 illustrates a process flow 100 for a method of populating an on demand tournament. Process flow 100 may be performed by a server or any other sufficiently provisioned computer system. In the tournament pool creation process 100 illustrated in FIG. 1, a player object 102 requesting assignment to an on demand tournament is initially assigned to entry pool 101 with a plurality of other player objects 102, collectively referred to as the player pool 104.

The tournament pool creation process 100 of FIG. 1 represents the process flow for one particular type of tournament. A service provider may offer any of a plurality of tournament types. Entry queues not depicted in FIG. 1 may exist for each of a plurality of tournament types. Examples of tournament types applicable to at least some on line games include without limitation: 4 Team Single Elimination, 8 Team Single Elimination, 8 Team Swiss, and so forth.

Each player object 102 may corresponds uniquely with an individual person. Each player object 102 may include attributes associated with the player's preferences and characteristics as well as attributes associated with pending tournament request. For example, each player object 102 may include one or more attributes associated with how long the player has been in the queue, i.e., how long the person has been waiting.

A tier processor 105 monitors entry queue 101 and periodically or non-periodically assigns a player object 102 from player pool 104 to one of a plurality of @106 in a tier group 110. Assignment of player objects 102 to a tier instance 106 in tier group 110 is primarily based on one or more skill level attributes of the applicable player object 102. Skill level attributes may include, as an example, an Elo rating or other suitable indicator of skill level determined based on previous documented competitions in the player's history.

The timing of player object assignments from entry pool 101 to a tier instance 106 in tier group 110 may also be influenced by one or more attributes, including player object attributes and attributes of the queue 101. All other attributes being equal or non-determinative, tier processor 105 may relocate player objects 102 in entry pool 101 to tier group 110 in a first in first out manner. Whenever a particular tier instance 106 signals tier processor 105 that it needs an assignment, tier processor 105 identifies a player object 102 having an appropriate or the most appropriate skill level attribute whose wait time attribute, adjusted by any applicable incentives or rewards offered by the tournament organizer, is the greatest and assigns the player object 102 to the appropriate tier instance 106 in tier group 110.

In some embodiments, however, a recent arrival to the player pool may be prioritized over a more distant arrival. As one example, the provider of the service may operate a loyalty rewards program rewards repeat player objects.

The degree of match required between the skill level attribute(s) of a player object 102 and the level of the tier instance 106 requesting an assignment may vary depending on factors including how many player objects 102 are in the player pool 104, how long has the request for assignment been pending, and the level of the applicable tier instance 106. For example, the highest and lowest levels of tier instances 106 may require a greater degree of skill level match to maintain the purity of the competition at the skill level extremes. Conversely, mid-level tier instances 106 may, in at least some embodiments, require a lesser degree of match. Of course these are just example implementations. Other implementations may require uniform and exact match of a skill level attribute and skill level attribute of a player object 102. Still others may impose any other suitable rules for assigning player objects 102 to a tier instance 106 in tier group 110.

Once a player object 102 enters a particular entry pool 101, a timer commences to indicate how much time has transpired between the player object 102 request and the commencement of a corresponding tournament. The amount of time required to obtain sufficient players of appropriate skill levels is a strong function of the number of player objects 102 in the player pool 104 and the degree of specificity or match that the service provider is imposing on the tournament. While tournaments requiring a higher degree of competitive match may represent the most competitive experience, stricter match requirements may result in longer queue times for all players.

To address the queue time issue, at least some embodiments may impose dynamic matching requirements wherein, as the time-since-request increases, the degree of match may be relaxed to expand the pool of player objects 102 eligible to participate in the tournament. Like the tier processor 105, a player object 102 may also impose degree-of-match preferences and/or constraints to and these constraints may also be relaxed over time in response to a queue time exceeding a particular one or more threshold values.

FIG. 1 illustrates the scope of the degree-of-match attribute, conveyed by the diameter of each tier instances 106 increases as the elapsed time indicator 120 increases. Accordingly, as the elapsed time increases degree of match required decreases and the scope of eligibility increases. FIG. 1 illustrates that, at some point, the scope of eligibility between two adjacent tier instances 106 may overlap. When this occurs, a player may be eligible for play in either of the applicable tournaments and assignment of player objects 102 may require a rule set or contention policy to determine which of two or more requesting tier instances 106 is assigned an eligible player. Like the tournament queues experienced by the player objects 102, the amount of time a tier instance 106 has been waiting for its next player as well as the degree of progress towards completion may influence the assignment of a player eligible for two tier instances 106. For example, all other attributes being equal, a tier instance 106 needing just 1 more player to commence a tournament may receive a player object assignment before a second tier instance 106 that requires two or more players before it can commence a tournament. Some embodiments may prioritize assignments based on the comparative levels of the two or more tier instances 106 requesting an assignment.

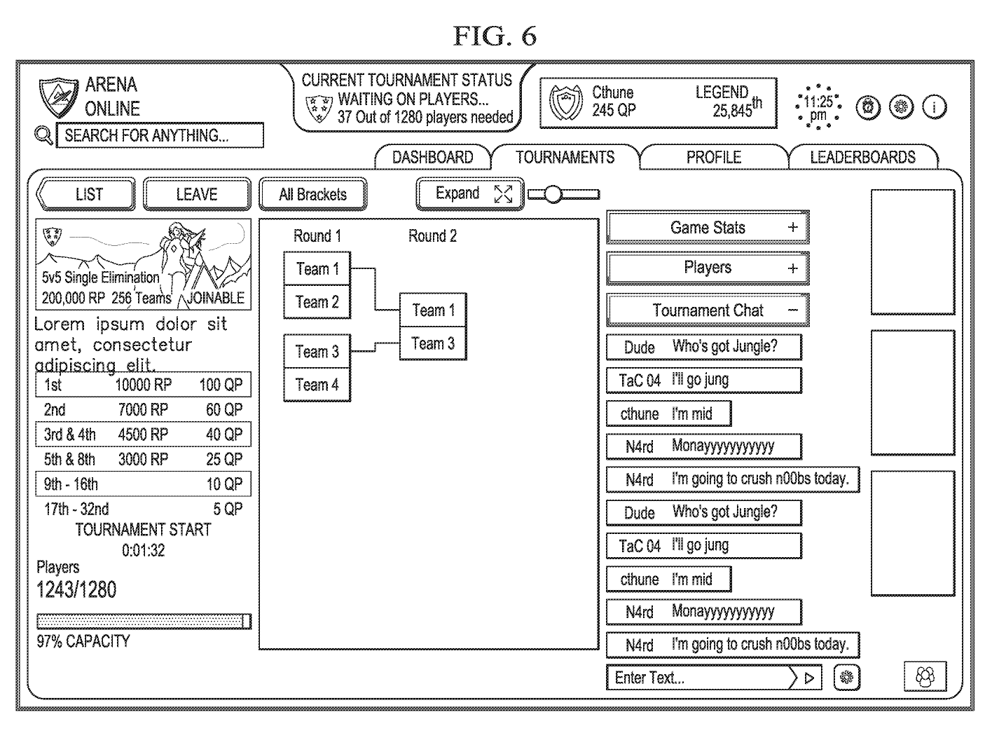

The uppermost tier instances 106 illustrated in FIG. 6 are shaded to convey the progress of filling the tournament. This simultaneous visual representation of the degrees of progress towards completion and the scope of eligibility or the degree of match currently required, may be generated by the tournament organizer and displayed to an administrator.

At the time, T3, illustrated in FIG. 1, the tier instance 106 is fully populated and may be launched to commence the tournament. Once a tier instance 106 is full, the corresponding tournament may commence and a new tier instance 106 at the same level of skill may be generated, thus implementing a continuously available tournament at each level of skill. When a tournament is released from the formation stage of FIG. 1, the tournament may then proceed to the team creation process.

In this manner, the tournament pool creation process 100 illustrated in FIG. 1 provides a continuously available process for launching on demand tournaments. During periods when the player pool population is very high, tournament pool creation process 100 may impose additional and more narrowly defined tiers while, conversely, when the player pool population is low, tier granularity may be increased.

Summarizing the tournament pool creation process 100 of FIG. 1, When a player object 102 requests tournament entry, the player object 102 may choose one of many tournament options, e.g., a 4 team single elimination tournament. Once a player declares himself eligible for a tournament by entering the queue, FIG. 1, the system may then take the player's assessed strength, which may be computed based on a skill-based matchmaking rating system. Once the player's strength is identified, the system may place the player in a tier of similarly (but not limited to) skilled players.

Once in an assigned tier, if the player is the first to join, the tier may begin its search to find other, similarly skilled players to fill the tier with the required amount of players to launch a tournament. Initially, the search criteria may be strict, looking for closely grouped players from a skill perspective. Over a period of time, if the tier is not filling fast enough, the search criteria may begin to loosen its criteria and search a broader spectrum of players.

Once the tier is full with the appropriately assigned players, the next phase may then commence, to where those players are joined into a tournament and the team creation process begins.

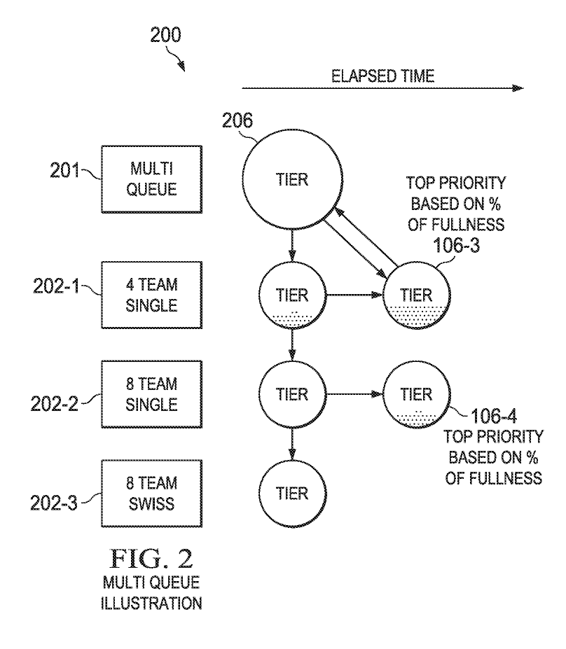

Referring now to FIG. 2, a process flow referred to herein as the multi-queue flow is illustrated. Rather than electing to queue up for a particular type of tournament, a player object 102 may elect to “stand” in a first-available tournament queue referred to herein as the multi-queue 201. The multi-queue 201 may be useful for player objects 102 who do not have a preference on tournament type, and place higher priority on shorter wait time. The player object 102 may distribute based on suitable criteria a player object 102 into any of the tournament-specific queues such as the queue described with respect to tournament pool creation process 100 in FIG. 1.

The multi-queue flow illustrated in FIG. 2 depicts three tournament-specific queues 202 including a 4 Team single elimination queue 202-1, an 8 team single elimination tournament queue 202-2, and an 8 Team Swiss que 202-3 are available. FIG. 2 illustrates a multi-queue pool 206 analogous to the tier instances 106 of FIG. 1. In the example illustrated in FIG. 2, the multi-queue 201 operates at a single tier wherein every tournament specific tier at every level may obtain assignments of player objects 102 from the multi queue 201. FIG. 2 illustrates that tier instances 106 of the same elapsed-time have equal access to multi-queue player objects 102 until, at some point, two tier instances 106 competing for player assignments are prioritized based on the player-to-completion parameter, i.e., the tier instance 106 requiring the fewest player objects 102 to launch a tournament gets priority. Thus, for example the tier instance 106-3 has priority over tier instance 106-4 because the two tier instances 106 have the same time elapsed age, where tier instance 106-3 has a higher player-to-completion value, i.e., requires more players. The comparative progress of the two tier instances 106 is, again, indicated by the shading in FIG. 2, where it appears 8 team tier instance 106-4 is approximately 35% full and the 4 team tier is approximately 75% full.

The multi-queue system may take into account several factors, that include but are not limited to, the skill level of players, the percentage of fullness of a tier making a request to the multi-queue, and amount of time that a tier and players have been waiting.

These factors, as well as others, may reduce the amount of time that a player waits in a queue to participate in a tournament. The multi-queue system may provide a supplement to the other queues, allowing tournaments to launch more rapidly and increasing the quality of the user experience.

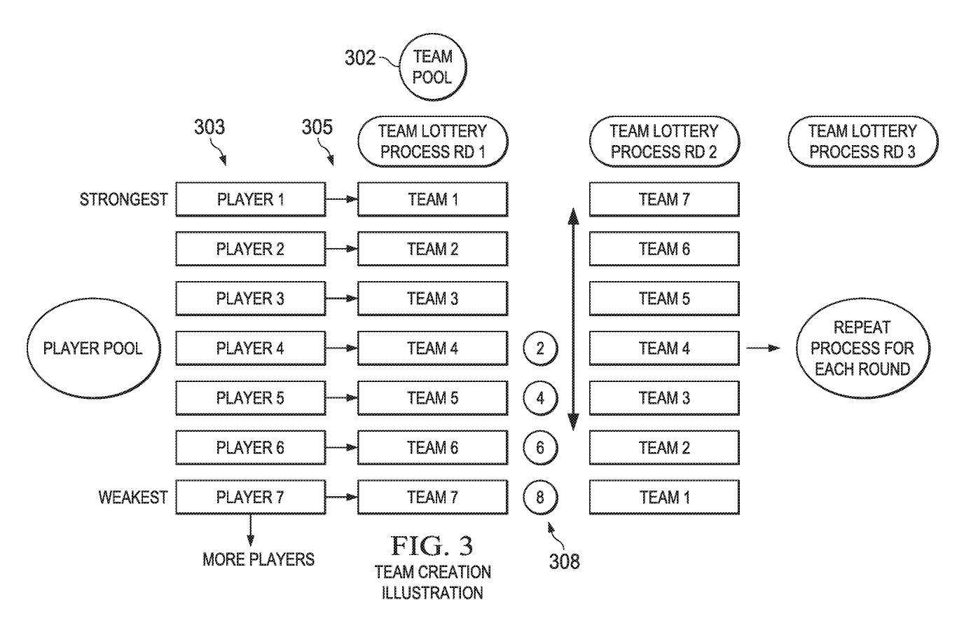

FIG. 3 illustrates a team creation process 300 executed after a player pool 301 has been finalized as in FIG. 1. When a tier instance 106 (FIG. 1) acquires enough player objects 102, a tournament can launch, but not before the player objects 102 are assigned into team pools 302 using the team creation process 300 illustrated in FIG. 3. As depicted in FIG. 3, the player objects 102 in the player pool 301 are sorted (operation 303) according to skill level and then assigned (operation 305) to teams based at least in part, on the player rankings, with the strongest player going to the team that picks first. After each round of assignments, the team selection order for the next round is held. In this manner, each team's position in any give round is randomly assigned, resulting in a greater probably of a truly random distribution of skill level among the various teams.

At the completion of a round of assignments, each team may be assigned points 308 based on the strength of the applicable roster at that time. The roster points may be used to influence the selection order in the subsequent round of player assignments. In some cases, higher roster points indicates less skill strength and may make it more likely that a team will obtain a higher, i.e., earlier or better, selection in the next round of assignments. Team roster points 308 may be used to improve parity within the team formation process by adjusting the pick order after each round or at some other interval to provide weaker teams with access to the strongest remaining players. The system may randomly select the team pick order, with probability applied through the point system. Once the pick order for that round is set, the points may be reset back to 0.

The pick order may be determined following each round. FIG. 3 illustrates the teams picking highest in the first round picking later in the second round. The three teams that acquired no roster points in the first round may be ordered for purposed of the second round selection by a randomizer with applied probability. The appropriate number of teams may be determined based on tournament type and/or player pool size. The team lottery system adds an element of randomization to the team selection process. This process may be done to reduce collusion or cheating efforts.

To summarize the team selection of FIG. 3, in the first round, teams may be placed in a pick order randomly. At the conclusion of each round, the team with the weakest player is awarded the most points, and scales down to 0 points to the team with the strongest player. In this instance, if a team had 8 points, that team would have eight chances out of X to get picked.

This process may continue until each player is assigned to a team. Once the teams are created, the seeding/pairings for teams may be created and player object 102 may be pushed into a team pool 302.

The team creation process organizes players into teams with a priority on balancing the overall skill of each team within a given tournament. This allows players who are not associated with an organized team to participate in a tournament on an equal footing with other teams in the tournament, regardless of skill level. This illustration is one of many iterations of the team creation and balancing process.

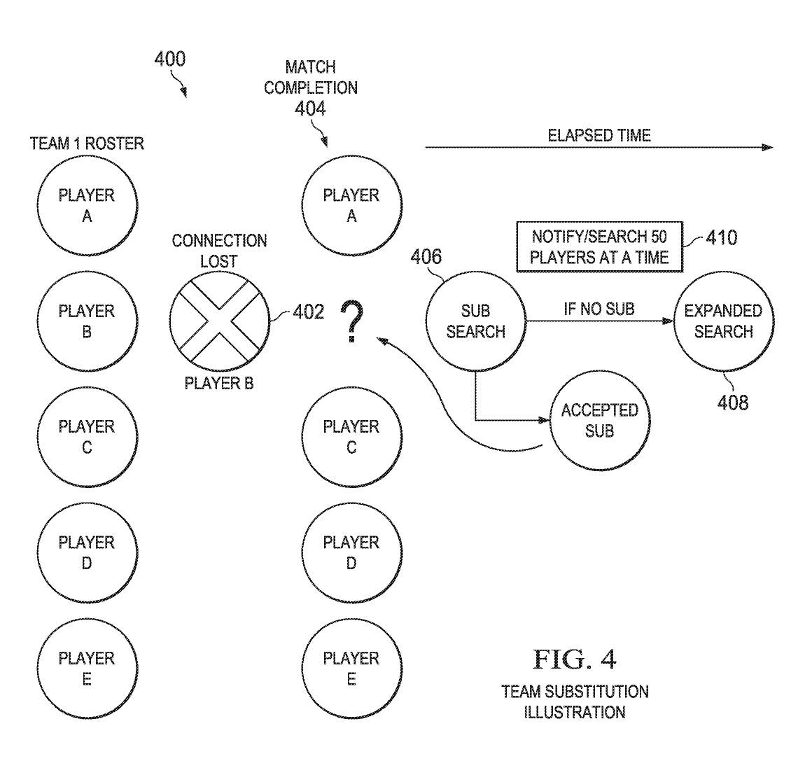

FIG. 4 illustrates element of a team substitution process 400 in which a team that loses a player while a tournament is in progress may acquire a replacement for that player before the next round of the tournament commences. For the purpose of this illustration, we assume 5 players on each team. As depicted in FIG. 4, the Team 1 roster includes players A-E.

FIG. 4 illustrates Team 1 Player B losing (402) a network connection while a match is in progress, leaving Team 1 at a numerical disadvantage, with only 4 players against the 5 players of other teams in the tournament. When the match completes, assuming Team 1 has not been eliminated and the team is otherwise still in the tournament, the substitution process illustrated in FIG. 4 will recognize that Team 1 is missing a player. FIG. 4 illustrates substitution process in which the skill level attributes of the player now missing, Player B in the example, are used as the basis for searching for a suitable replacement. As was true when the player pool was first determined, the system begins its search for a replacement player, the search criteria may be restrictive (block 406). As time elapses, the search criteria may loosen (block 410) and expand its search to find a player in a reasonable amount of time.

Once the search criteria has been assessed, the system may notify multiple eligible standby players, for example, 50 players at a time that a roster spot is open. After a brief period of time, the system may notify an additional 50 eligible players. This process may continue until a user accepts the substitute position. Once a replacement player object 102 accepts the substitute role, the search closes. The player object 102 that accepts is then placed into the 302 (FIG. 3) team lobby with the remaining team members.

The player substitution process 400 is designed to aid teams that lose members due to unforeseen circumstances, such as internet connection drop, emergencies and prior obligations. In this manner, teams remain balanced in terms of skill and in numbers for each new game. Variations of the substitution feature may include restricting the eligible players to players indicating a position preference corresponding to a position of the player whose connection was lost. In another variation, the opposing team may be offered compensation if the substitution process results in an increased team skill level. Compensation might be any suitable type of advantage, whether temporary or not. Another variation may include, leveling the competitive field in the event no suitable eligible player is available to substitute. Leveling the competitive playing may include, as an example that would be discretionary with the second team, permitting the second team to continue play after removing one of their own players.

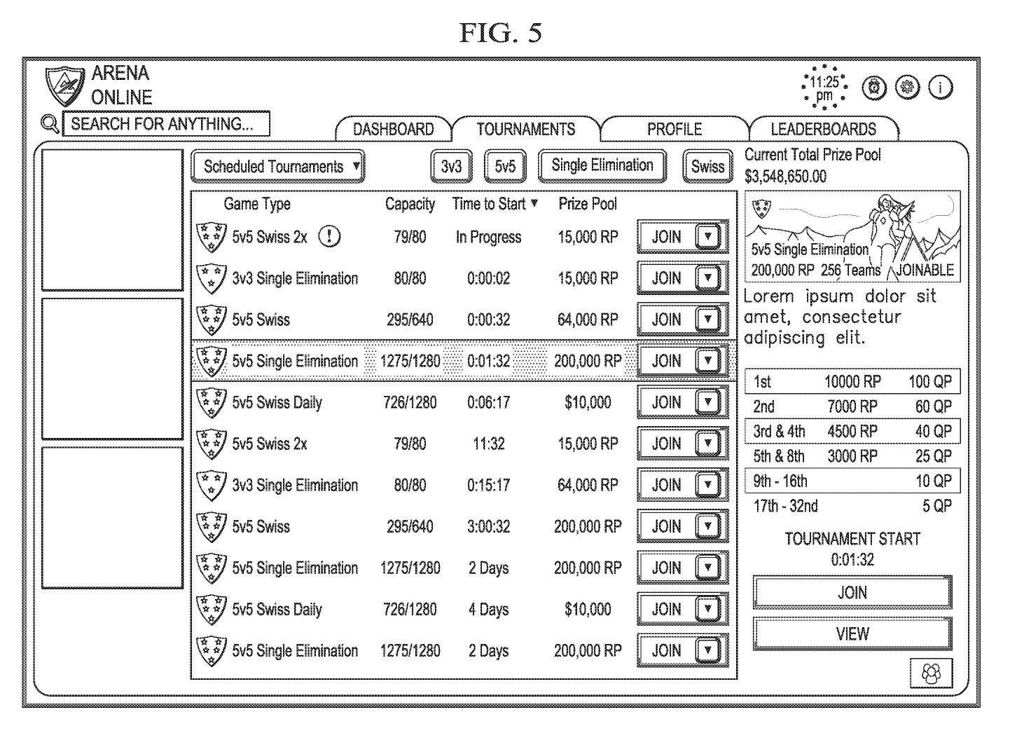

FIG. 5 is a screen shot of an exemplary Tournament Lobby.

FIG. 6 is a screen shot of an exemplary Team Lobby.

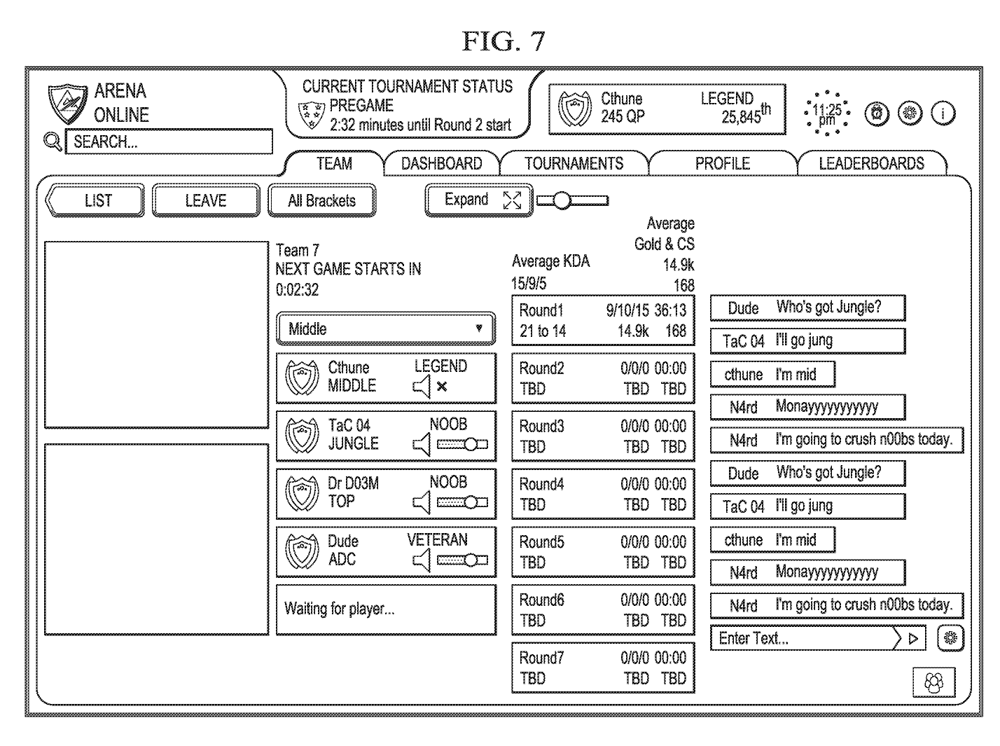

FIG. 7 is a screen shot of an exemplary Tournament Bracket.

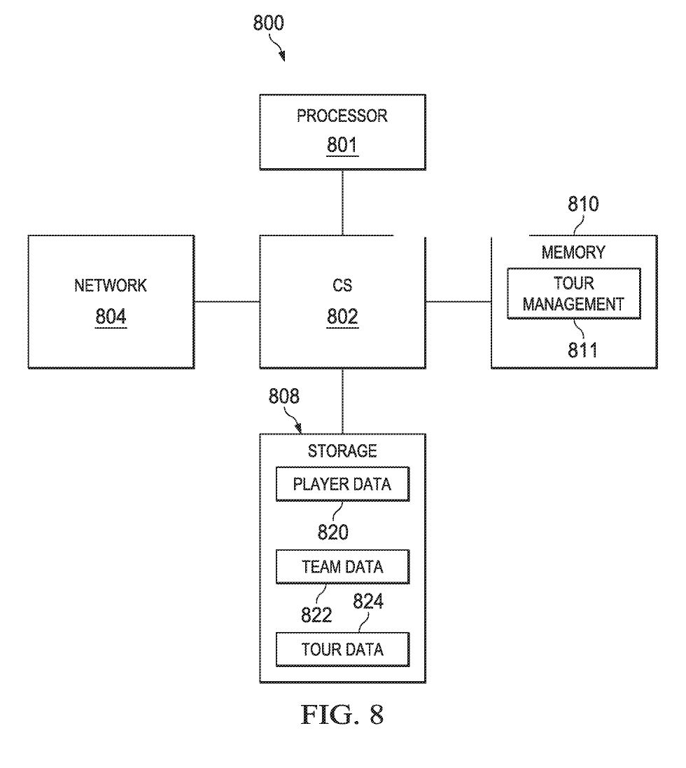

FIG. 8 illustrates a server 800 suitable for implementing the on demand tournament management features and user interfaces of FIG. 1 through FIG. 7. Server 800 includes a processor 801 coupled to a memory 810 and a chip set 802. Chip set 802 couples processor 801 to a network interface 804, enabling server 800 to communicate with remotely located players via one or more network connection including, in at least some embodiments, Internet connections. Chip set 802 further couples storage medium 808 to processor 801. The storage medium 808 may include a data base of information including player data 820, including player identification information, player preferences information, and player attribute information including, as an example, player skill level information for one or more positions and for one or more tournament types and/or on line games. The storage medium 808 further includes team data 822 indicating team rosters and the player data for each of the players in the team. The team data may include, for example, team skill level data compiled or calculated based on the collection of players on the team's roster. The storage medium 808 may further include tournament data 824 including information regarding the teams in the tournament, the team statistics, including wins and losses and so forth. The tournament data may further include information regarding players in the various queues and/or pools for purposes of generating a next tournament and/or for purposes of implementing substitution features described herein. Memory 810 is illustrated including tournament management application 811, which may include modules for maintaining the features disclosed with respect to FIG. 1 through FIG. 7.

In summation disclosed subject matter includes:
1. An on-demand queue system that allows players to join unscheduled tournaments, which launches a tournament once the queue is full.
2. A multi-queue function that allows players to enter into several queues at once, with preference on reduced wait time over tournament type.
3. The team creation process that takes individual players and organizes them into teams based on a set of criteria for a tournament.
4. Team substitution process that assists teams with missing players by finding an eligible replacement player for that team in between rounds.
5. A matchmaking and team creation process as it applies to an automated tournament platform

The subject matter disclosed herein has been described in an illustrative manner, and it is to be understood that the terminology which has been used is intended to be in the nature of words of description rather than of limitation. Obviously, many modifications and variations of the disclosed subject matter are possible in light of the above teachings. For example, during the team creation process, we apply the lottery system to the teams, but the lottery system may be employed with respect to players as well. It is, therefore, to be understood that within the scope of the claim, the disclosed subject matter may be practiced otherwise than as specifically described. The drawings and screenshots provided are provided for illustrative purposes, and intended as visual representation of the illustrative description rather than of limitation.

What is claimed is:

1. A substitution method, comprising:
maintaining first roster information for a first team and second roster information for a second team;
responsive to detecting a lost connection corresponding to a first player of the first team, performing operations comprising:
accessing first skill level attributes of the first player;
performing a search for a replacement player for replacing the first player in accordance with the first skill level attributes, said performing comprising:
offering at least some eligible standby players, determined in accordance with criteria for matching the skill level attributes of the first player, a substitution spot corresponding to the open roster spot;
monitoring for an acceptance from an eligible player;
responsive to not receiving an acceptance, offering additional eligible standby players the substitution spot; and
responsive to receiving an acceptance, terminating said search.

2. The method of claim 1, wherein said offering additional eligible players includes relaxing a degree-of-match requirement to increase a quantity of eligible players.

3. The method of claim 1, wherein said offering occurs following detection of a match during which said connection was lost.

4. A method of claim 1, wherein said skill level attributes include an Elo attribute determined at least in part from performances during prior tournaments.

5. An on line tournament management server, comprising:
a processor; and
a memory, accessible to the processor, including processor executable program instructions that, when executed by the processor, result in tournament management comprising:
maintaining first roster information for a first team and second roster information for a second team;
responsive to detecting a lost connection corresponding to a first player of the first team, performing operations comprising:
accessing first skill level attributes of the first player;
performing a search for a replacement player for replacing the first player in accordance with the first skill level attributes, said performing comprising:
offering at least some eligible standby players, determined in accordance with criteria for matching the skill level attributes of the first player, a substitution spot corresponding to the open roster spot;
monitoring for an acceptance from an eligible player;
responsive to not receiving an acceptance, offering additional eligible standby players the substitution spot; and
responsive to receiving an acceptance, terminating said search.

6. The server of claim 5, wherein said offering additional eligible players includes relaxing a degree-of-match requirement to increase a quantity of eligible players.

7. The server of claim 5, wherein said offering occurs between rounds of a particular tournament.

8. A method of claim 5, wherein said skill level attributes include an Elo attribute determined at least in part from performances during prior tournaments.
